(19) United States
(12) Patent Application Publication
(10) Pub. No.: US 2014/0278474 A1
(43) Pub. Date: Sep. 18, 2014

(54) Helping People with Their Health

(71) Applicant: Health Value Management, Inc., Louisville, KY (US)

(72) Inventors: Douglas J. McClure, Framingham, MA (US); Mary Beth Chalk, Austin, TX (US); Frederick C. Lee, Annandale, VA (US); Wendy Turenne, Alexandria, VA (US); Martin D. Adler, Wayland, MA (US); Greg Zobel, Murrieta, CA (US); Somu Vadali, Brookline, MA (US); Loretta Keane, Boston, MA (US); Robert A. MacWilliams, Auburndale, MA (US); Ramesh Kumar, Boston, MA (US); Costas Boussios, Boston, MA (US)

(73) Assignee: Health Value Management, Inc., Louisville, KY (US)

(21) Appl. No.: 13/841,553

(22) Filed: Mar. 15, 2013

(51) Int. Cl. G06F 19/00

(52) U.S. Cl. CPC G06F 19/3418
USPC 705/2

(57) ABSTRACT

Among other things, a computer-implemented method includes, on successive occasions over a period of time, gathering measured data and self-reported data that represent health states of participants in a health goal system, based on at least some of the gathered data, determining, by machine learning, data representing a relationship between sequences of self-applied interventions and health states of participants who belong to respective groups that share similar characteristics, calculating scores representing characteristics of interactions between participants and the health goal system, and based on the scores and the data determined by machine learning, choosing elements of conversations to be provided to the participants, elements of the conversations being chosen to affect (i) behaviors, (ii) health states, or (iii) health awareness, or a combination of any two or more of them, of the participants, the elements of the conversations comprising questions posed to the participants on user interfaces of electronic devices.

### BACKGROUND

This description relates to helping people with their health.

People can be helped with their health, for example, to maintain or improve it or slow down its decline using communication methods such as email, text messaging, social networking feeds, and others ways of communicating through laptops, smartphones, tablet computers, and other network connected hardware. These communication methods can provide information to a person in real time throughout the day including health related information that may be useful to the person in achieving a health-related goal.

### SUMMARY

In general, in an aspect, a computer-implemented method includes, on successive occasions over a period of time, gathering measured data and self-reported data that represent health states of participants in a health goal system, based on at least some of the gathered data, determining, by machine learning, data representing a relationship between sequences of self-applied interventions and health states of participants who belong to respective groups that share similar characteristics, calculating scores representing characteristics of interactions between participants and the health goal system, and based on the scores and the data determined by machine learning, choosing elements of conversations to be provided to the participants, elements of the conversations being chosen to affect (i) health behaviors, (ii) health states, (iii) health awareness, or (iv) health engagement, or a combination of any two or more of them, of the participants, the elements of the conversations including questions posed to the participants on user interfaces of electronic devices.

Implementations may include one or more of the following features. One of the scores comprises an indication of the likelihood that an individual will change health behaviors in response to interacting with the health goal system. One of the scores includes an indication of the likelihood that an individual will continue to use the health goal system. One of the scores includes an indication of the likelihood that an individual using the health goal system will reach outcomes beneficial to his or her health. The score is calculated based on at least one relationship between a lifestyle factor and an outcome. The score is calculated over time based on changes in the relationship over time. The score is calculated based on confounding factors. One of the scores includes an indication of the likelihood that an individual using the health goal system is at risk for health problems. The score is determined based on a health habit assessment provided to the individual. The score is determined based on changes over the course of multiple administrations of the health habit assessment. The method includes generating the conversations based on a tree of relationships among questions and answers. The method includes providing the conversations based on trigger events associated with each conversation. The method includes providing elements of the conversations at times determined based on a queue containing the elements. The queue comprises a priority for each element. The method includes establishing one of the groups based on multiple characteristics shared by participants of the group. At least one of the multiple characteristics is determined based on at least one of the scores.

In another aspect, in general, a system includes a coaching engine executable on a computer system and configured to pose, in a user interface, conversations chosen to receive data from a participant of a health goal system, and determine, based on the received data, at least one of (i) an indication of the likelihood that an individual will change health behaviors in response to interacting with the health goal system, (ii) an indication of the likelihood that an individual will continue to use the health goal system, (iii) an indication of the likelihood that an individual using the health goal system will reach outcomes beneficial to his or her health, and (iv) an indication of the likelihood that an individual using the health goal system is at risk for health problems.

Implementations may include one or more of the following features. The system includes a decision engine executable on the computer system and configured to, based on the determined indications, choose an intervention expected to affect, for the participant (i) a health behavior, (ii) the health state, (iii) a health awareness, or (iv) health engagement, or a combination of any two or more of them, of the participant.

In another aspect, in general, a computer readable storage device storing a computer program product including machine-readable instructions that, when executed by a computer system, carry out operations including providing, on a user interface of an electronic device, elements of conversations chosen based on an identity of a user of the electronic device, the user being associated with a health goal system that chooses interventions expected to affect, for the user (i) a health behavior, (ii) the health state, (iii) a health awareness, or (iv) health engagement, or a combination of any two or more of them, of the participant, in which providing the conversations comprises prompting the user to enter data usable to generate scores indicative of (i) the likelihood that an individual will change health behaviors in response to interacting with the health goal system, (ii) the likelihood that an individual will continue to use the health goal system, (iii) the likelihood that an individual using the health goal system will reach outcomes beneficial to his or her health, and (iv) the likelihood that an individual using the health goal system is at risk for health problems.

Implementations may include one or more of the following features. At least one of the conversations is chosen based on a previous conversation provided to the user. At least one of the conversations is chosen based on data received from a device used by the user. At least one of the conversations is chosen based on a change in one of the scores. At least one of the conversations is chosen based an action of the user with respect to the user interface. At least one of the conversations comprises a challenge posed to the user.

These and other aspects and features, and combinations of them, may be expressed as apparatus, methods, systems, and in other ways.

Other features and advantages will be apparent from the description and the claims.

### DESCRIPTION

FIG. 1 shows a health system.

FIG. 2 shows a system architecture.

FIG. 3 shows a software architecture.

FIG. 4 through FIG. 9 show user interfaces.

FIG. 10 shows a coaching framework.

FIG. 11 shows a chart.

FIG. 12 shows a diagram of variables.

FIG. 13 shows a chart.

FIG. 14 shows a flowchart.

FIGS. 15A through 16 show user interfaces.

FIG. 17 shows a tree representing a coaching conversation.

FIG. 18 shows a queue.

FIGS. 19A through 20 show user interfaces.

The techniques that we describe here are meant to help people individually with maintaining, improving, or slowing a decline of a state of their health. Typically, in what we describe here, a person has a goal (or more than one goal) for maintaining, improving, or slowing the decline of a state of his or her health. We call this a health goal. When we refer to a personal “health goal,” we include, for example, one or more criteria to be achieved with respect to the individual's health. A health goal can be, for example, a value or range of values of a measurable parameter (for example blood pressure) at one point in time or over a period of time. Non-measurable health states can also be health goals, for example, being able to exercise more with less pain. A health goal can have a final state to be achieved, such as a desired blood pressure level or desired blood triglyceride level, or can be an ongoing state, such as a minimum number of steps taken per week indefinitely. In general, a health goal, in the way we use the term is something that will not be achieved unless the individual changes her conduct in some way, compared to what it otherwise would be, in order to achieve the health goal. We broadly refer to the changes in conduct as interventions or individual interventions. Therefore, any intervention includes, for example, any action or behavior that an individual engages in or refrains from in order to reach a health goal. The intervention may be one that is conscious (for example, that the individual consciously increases the number of glasses of water consumed in a day) or unconscious (for example, that the individual unconsciously increases body hydration by eating more fruit). A variety of other kinds of health goals and combinations of them can be addressed by the techniques described here.

The techniques that we describe here include, for example, helping individuals to undertake interventions to reach their health goals.

Among other things, in some examples described here, an intervention is varied with respect to a particular health goal or goals. The variation is arranged over time or from time to time or only once. Changes in the measured parameters or healthcare technology or knowledge or changes in the goal or subjective information provided by the individual (and possibly a wide variety of other factors) can be used as the basis for determining how to vary an intervention to achieve a goal. In general, an individual is thought to be more likely to achieve a health goal if an intervention is adapted over time and is personalized to the individual.

The techniques that we describe here aim to cause individuals to engage in interventions to reach their health goals by communicating with them from time to time. We call these communications, in general, intervention messages. Intervention messages can take a very broad range of forms, can occur in a very broad range of times, can use a very broad range of communication media, and can be delivered through a very broad range of platforms.

As shown in FIG. 1, a health goal system 10 (also referred to as simply the “system”) is operated, among other things, to help a potentially very large number of people 106, 120 to reach specified health goals 126 using interventions 130 that are prompted by intervention messages 132. In addition to helping people with their health goals, the system can be used for a wide variety of other purposes, including the following: to reduce the cost of providing health care; to reduce the cost of insuring health care services and of paying for such insurance; to improve the services and benefits provided by employers and other institutions for people associated with them; to generate revenue as part of the operation of the system; to provide an advertising platform; to accumulate and study data that represents health states of people; interventions attempted over time to help people reach health goals; the results of the interventions, and related demographic information about the people, among other things; and to provide information to other systems about interventions, intervention messages, results, and their relationships to health states of people, for a variety of uses; and to interact with other websites including social networking sites, search sites, and others.

System 10 includes a data aggregation engine 102 that collects data from multiple sources associated with multiple individuals and also includes an intervention selection engine 104 that uses the collected data to determine an intervention (for example, an intervention that is considered to be most likely to succeed) to be applied to an individual 106. Together, in some implementations, the data aggregation engine 102 and intervention selection engine 104 use machine learning to determine an appropriate intervention for a target individual 106 given the data available at a point in time. We sometimes refer to the combination of the data aggregation engine 102 and intervention selection engine 104 as the decision engine 100), and to the determinations that it makes regarding interventions as decisions.

The decision engine 100 analyzes data and generates control decisions for other system elements, and serves as the central controller for how the health system interacts with individuals (we sometimes refer to as participants). As data becomes available about participants, the decision engine 100 can take advantage of the data to tailor its interactions with a given participant. Two approaches to tailoring are the selection of interventions that are expected to achieve a particular health goal and the generation of data allowing examination of which interventions work best for different types of participants. For example, participants can be assigned to groups that have different characteristics to explore which interventions lead to better results with respect to respective groups. In some examples, a participant may be assigned to a group according to the participant's age to evaluate whether interventions associated with an age group are appropriate for the participant, and the participant may also be assigned (at the same time or at a different time) to a group according to the participant's gender to evaluate whether interventions associated with gender are appropriate for the participant.

While the data aggregation engine 102 and intervention selection engine 104 are represented in FIG. 1 as discrete components, they need not be coherent structures such as software programs or network servers. The data aggregation engine 102 and intervention selection engine 104 can each be made up of multiple software and/or hardware components, and both engines can themselves be part of a single unit, for example, software running on a computer system or cluster of servers.

The data aggregation engine 102 performs a wide variety of data collection activities. For example, it collects data about an individual 106 indicative of a health state of the individual. One type of data collected can be data measured by an electronic device 108 such as a pedometer, blood pressure cuff, glucose monitor, sleep monitor, or any other kind of device that could be used to collect data. This measured data 110 can include meta-data, such as the location and time at which the data was collected. Another type of collected data can be data 112 that is self-entered by the individual 106, including quantitative information such as amount of foods eaten or hours slept as well as qualitative information such as self-perception of mood or stress level. The self-entered data 112 can include data evaluating the intervention, such as an indication by the individual that he likes or does not like the intervention, or an impression by the individual that the intervention is working well or not. The data can be entered electronically on a mobile device 114 such as a smart phone or another type of electronic device 116 such as a computer, for example. The collected data can include a very wide variety of data, including any data that is indicative of, a measure of, or related to any aspect of the individual's condition, motivation, or feeling that bears on a state of the individual's health, interventions, intervention messages, or health goals. The sources of the collected data can vary widely and include any kind of device, hardware, platform, system, software, or other instrument that can provide such data.

In addition to collecting data from an individual for whom the system is to provide interventions to help the individual reach a health goal, the data aggregation engine 102 can collect data 118 (measured and/or self-entered) from many other individuals 120 and use the collected information to determine what types of interventions (and sequences of interventions) succeed for a particular individual, and also what types of interventions (and sequences of interventions) are likely to succeed for a category or group of individuals. The data aggregation engine 102 does this by analyzing the data in an ongoing fashion to find patterns of success and failure for different types of interventions 122 (and sequences of them). The data aggregation engine 102 can also examine patterns among multiple individuals to categorize individuals into one or more categories of individuals who may respond similarly to similar kinds of interventions 122 (and sequences of them).

Generally, any individual has several characteristics that define the individual. Characteristics can include physical characteristics such as the individual's age, height, weight, and gender, and characteristics can also include other types of information potentially relevant to health, such as whether the individual smokes and whether the individual has a dangerous occupation.

The other individuals from whom or with respect to how data may be collected may include individuals for whom the system is selecting and providing interventions and intervention messages as part of its normal operation. The other individuals may also include people who are not active participants in the system.

The intervention selection engine 104 chooses one or more interventions 122 (or sequences of them) to apply to a target individual 106 participating in the health goal system 10. A wide variety of inputs can be used by the intervention selection engine 104 in making such choices.

One input that the intervention selection engine 104 uses to make choices is one or more health goals 126. Each health goal 126 can be selected by the target individual 106, for example, or another entity such as the target individual's doctor. Another input is analyzed data 128 provided by the data aggregation engine 102, including data based on data 110, 112 collected from the target individual 106 and data 118 collected from other individuals 120.

Other inputs could include data derived from research, hypotheses about interventions that may be effective, interventions proposed by third party vendors or partners of a host of the system, and others.

The intervention selection engine 104 uses the health goal or goals 126 (which we sometimes refer to simply as the goal) to select an intervention 130 (or multiple interventions or a sequence or sequences of the interventions) appropriate for that goal, and uses the analyzed data 128 to choose intervention messages to be sent to the individual to cause or attempt to cause the interventions to occur.

Generally, the interventions 122 can include intervention categories 123 from which to choose. An intervention category is a type of intervention (for example, attempting to reduce the intake of caffeine) to which multiple interventions can belong. The particular intervention 130 chosen from among the intervention categories 123 represents a particular set of actions that can be carried out to achieve the desired result of the intervention category 123 of the intervention 130. For example, the particular intervention 130 could be attempting to get the participant to drink less coffee by making suggestions to drink less coffee in the morning, as opposed to the evening during which the participant is unlikely to be drinking any coffee.

An intervention 130 to change a target individual's behavior may be executed by sending intervention messages 132 to the target individual 106 regularly. For example, each morning the individual could be prompted to reduce your intake of caffeine from three cups of coffee to one cup. The analyzed data 128 may indicate approaches that have had success for the target individual 106, or approaches that have had success for individuals similar to the target individual for the same health goal 126. This may mean sending messages more frequently, less frequently, more sternly worded, less sternly worded, and so on. This may also mean planning intervention messages to be provided in the short-term for the target individual 106, or planning intervention messages to be provided over a long-term for the individual. These alternatives can be characterized as features of a generic intervention, and the analyzed data 128 allows the intervention selection engine 104 to choose the best features after choosing an intervention 130. The intervention messages 132 can be sent to the target individual 106 in any number of formats and using any number of channels. For example, the intervention messages 132 can be sent to a mobile device 114 or another kind of electronic device 116 used by the target individual 106. Virtually any kind of intervention message and any mode of delivering the intervention message that has a prospect of succeeding in the intervention and helping the individual to reaching the health goal could be used.

The data aggregation engine 102 and intervention selection engine 104 use machine learning to identify interventions and intervention messages to apply to a target individual. We use the term “machine learning” in a broad sense to include for example, any approach in which a computer system develops a store of data that can be applied to algorithms that improve as more or better data becomes available. For example, an algorithm that accomplishes a particular computational task may perform that task more efficiently or with more accurate or more precise results as the associated computer system receives (or “learns”) more data.

The data aggregation engine 102 is the component of the decision engine 100 tasked with “learning” based on the data received. The data aggregation engine 102 does this by generating decision models 124, which are descriptions of the expected behavior of elements that interact with the decision engine 100. The decision models 124 are generated based on an analysis of the data received. For example, some decision models 124 could describe how different participants may behave when certain interventions are applied to them. These decision models 124 may be tailored to a particular category of participant, such as participants of a certain age group, gender, or other characteristics of the participant.

The decision engine 100 uses machine learning to tailor interactions with a participant (that is, selects appropriate intervention and appropriate intervention messages) in order to achieve one or more particular health goals. The decision models 124 can be based on externally-provided control logic (e.g., expert systems) or developed based on analysis of historic participant interactions (e.g., neural networks) or hybrids of these types of approaches are used when multiple options for interacting with a participant are available, to determine which of the multiple options is best matched with the participant. Further, the decision engine 100 can automatically initiate the creation, updating, and exploitation of decision models 124 used in the decision-making process as well as to make control decisions in order to generate data that supports the training, testing, and validation of the decision models 124.

One approach to model generation uses data (e.g., historic data) from participants (e.g., past participants) to train decision models 124 that then attempt to predict which interaction options (our reference to interaction options includes, for example interventions and intervention communications) that may have a chance of contributing to achieving a goal. In this situation, existing data is analyzed to determine how accurate one or more participant characteristics can be in predicting the likelihood of an interaction option contributing to a successful outcome. Data from historic participants is combined with information about measured outcomes (for example, whether or not a participant achieved a goal that was the focus of an intervention), and a model such as an artificial neural network trained to then be able to predict which participants will demonstrate which levels of success. If the model can achieve a threshold level of validation, it will then be made available for use in future decisions. For example, if a model can be used to identify an intervention that achieves associated health goals, and does so for a certain percentage of participants a certain percentage of time, the model can be deemed “valid.”

Another approach, useful in conditions where limited amounts of historic data are available, is to use a clustering technique which entails assigning participants exposed to similar interaction options into two or more groups (“clusters”) based on their outcomes. This has the advantage of identifying a set of characteristics of participants that may predict whether or not a particular participant will be successful given the interaction option. Statistical analysis of historic results can then be used to evaluate if the data shows a significant difference between two or more clusters, or even a tendency that does not yet achieve significance. In cases where a statistically significant difference is seen, the clusters are made available for use in future decision-making. Where a potentially significant result is obtained, the system can identify what additional information is needed in order to better evaluate the statistical significance and then implement steps to collect that data, for example by assigning future participants to interaction options in order to complete a set of data points. As this additional information is made available, it is automatically evaluated to determine if it calls for an update to the models available for use in future decisions.

The system's ability to automatically determine how to address data gaps and enable more effective evaluation of participant characteristics' predictive capabilities can make it increasingly capable as it is used by ever larger numbers of participants. Existing data may not have been collected in such a manner to allow a statistically significant result to be achieved, for example because the number of participants sharing a set of characteristics is not large enough to provide a statistically significant sampling. The system can assign future participant interactions in a way that addresses data deficiencies and adapts to participant responses as they happen, responding to conditions such as participant dropout and additional participant enrollments. Alternatively, if the predictive model requires a range of input values that are not available for a particular participant (e.g. answers to a set of question about activity and diet), the system can identify that a required input is lacking and take an action (e.g. posing the question to the participant to solicit the response and complete the required input data or requesting the participant take a measurement).

In addition, the system can adapt future interactions based on the evolving evaluation of efficacy, e.g. if a statistically significant predictive capability of a participant characteristic for determining that a particular interaction is effective is found, further experimentation can be curtailed so that all future participants (or an increased proportion) are assigned the feature in response to their exhibiting the participant characteristic(s). Another type of data deficiency that can be addressed is the lack of specific input characteristics for a set of participants. This can happen, for example, when one population of participants does not answer the same set of enrollment questions as another population. If one or more of these enrollment questions are found accurate in predicting the efficacy of an interaction, the question(s) can be added to the interactions that will be executed for those participants, so that participants' responses are then available in determining who will be exposed to the feature.

FIG. 2 shows a system architecture 200 demonstrating how the decision engine 100 uses available resources to interact with a target individual 106 (participant).

The model library 202 contains parameters of models used by the decision engine 100 in the process of generating control decisions or of analyzing participants and groups of system participants, as well as the models themselves. The models can be the decision models 124 shown in FIG. 1, for example. Models that are applicable to the general participant population are stored together with participant-, cluster-, or population-specific models that incorporate information about the specific participant/cluster/population that it will used for.

App servers 204 (application servers) generate the content that allows web browsers, mobile devices, and other software and hardware to interact with participants of the system. The content represents the actual information that the participants views, reads, and otherwise interacts with including, for example, intervention messages 132 shown in FIG. 1. As an example, a participant may interact with a web application to complete an initial health survey, or with a mobile application to record an activity they engaged in, or be prompted by a medical device to take a biometric reading. The app servers 204 component of the system allows decisions about how to communicate with participants and the goals of an intervention to be handled separately from the communication capabilities and limitations of a specific device. In this way, the system is “device agnostic”—the core functionality of the system can work with any of several kinds of devices, includes devices not yet known when the system begins operation. The content, or messages, could contain text, audio, video, animations, or some combination of these, depending on the capabilities of a device being used to receive the content.

A wide range of biometric sensor devices 206 can produce measurements and data that contribute to characterizing and understanding the health of a target participant. Measurements from a range of devices will be accepted by the system and used as the basis of decisions about how to interact with the target participant, both in identifying optimal interaction approaches and in establishing target health and wellness goals and strategies. Data from devices may be accessed directly or through one or more intermediary steps. For example, a data hub in a home can collect information from multiple devices and publish it to a database (for example, the data archive described below) that the data aggregation engine can then access through the Internet.

To accommodate the range electronic communication methods that target participants may use in their work and private lives, a communication servers 208 component of the system allows a single message to be delivered in any (or multiple) of a wide variety of communication modalities including but not limited to email, voicemail, text messages (SMS), a twitter feed, messages generated in and/or delivered through social network services, etc. The communication servers 208 component is also extensible, enabling the health system to incorporate additional communication modalities and opportunities that may become available.

The content library 210 is a repository of health and wellness information and media that is available for the system to present to participants. Content can include different media types (e.g. text, audio, audiovisual) and can be stored as media in the content library 210 or the content library 210 can serve as a mediator between a system-internal reference to a specific media item with an external resource (e.g. one of the communication servers such as a web server) that can provide the media item to the system or to a participant.

The data archive 212 stores information about participants and populations. Biometric measured data collected by devices (e.g., pedometer readings over time), historic information about interactions that occurred (e.g., history of when a participant has logged into the system or otherwise used the system), and participant responses 214 to questions 216 (e.g. responses to a set of questions posed in an enrollment questionnaire) are stored in the data archive 212 and made available to other system components. In addition to raw data, processed and summarized data can be stored (for example, the analyzed data 128 shown in FIG. 1). As an example, participant pedometer readings collected each hour can over time be replaced in the data archive 212 with summarized information like overall steps per day or week or even longer periods of time. The data archive 212 covers the functionality of online-accessible data resources, e.g. digital records accessed from a professional health care office. In some examples, measured data can include data measured about a user's interaction with the health goal system 10, e.g., number of times a user logs into a user interface associated with the health goal system 10.

FIG. 3 shows a software architecture 300 that can be used to implement the decision engine 100, including services used by the decision engine.

A rules execution service 302 can execute one or more rules 303 expressed in terms of “If <condition> then <action>”, implementing what are also referred to as “Expert Systems”. The rules execution service can allow for the creation and editing of a set of rules 303 as well as the evaluation of the correct action to take given a specific scenario.

A clustering analysis service 304 can implement one or more clustering techniques, e.g. k-means clustering, to assign participants to a particular cluster or group of participants based on similarity with other members across the range of possible characteristics of participants. The number of clusters 305 (groupings of participants) can be pre-determined or an adaptive version of the algorithm used that adjusts the number of overall clusters based on criteria such as minimum number of members in a cluster or a metric reflecting the similarity of members of the cluster 305.

A Bayesian network service 306 can allow partial knowledge or beliefs about a domain to be captured in a probabilistic model/framework and then used to make decisions. Incorporation of Bayesian networks 307 (a type of decision model) as a decision-making approach allows the system to leverage domain knowledge and expert hypotheses about potential causal and correlation relationships between participant characteristics and between participant characteristics and outcomes without requiring codification of a set of strict “if . . . then” statements. Further, the Bayesian framework allows decision models that begin with expert-generated parameter values to be updated based on long-term data collections, merging expert-provided with data-driven parameter evaluations. Because Bayesian networks 307 are robust to incomplete input data sets, which is the condition we expect to be prevalent given the overlapping input information we have about participants, the use of Bayesian networks 307 as decision models can be one of the main machine learning techniques used by the system.

A neural network service 308 can use techniques, e.g. backpropagation-trained feed-forward artificial neural networks 309 and also use outcome information to automatically generate a mapping from a multi-dimensional input feature space to a decision (e.g. the extent to which a feature should be exposed to a participant). Neural networks 309 can be used where a set of outcome categories (e.g. successful engagement, unsuccessful engagement) can be associated with a set of participant outcomes and where the goal is then to determine how to effectively map from known participant characteristics to a decision about how to interact with the participant.

A statistical analysis service 310 can provide access to higher-level statistical analysis of a participant's data or of data over a population or other grouping (“cluster”) of participants sharing characteristics. Within the decision engine, the statistical analysis service 310 will be used for simple tasks like generating common statistics 311 of groups of data (e.g. to determine an average daily step count from hourly step data) to complex things like determining if the distributions of results values across two groups of participants belies a statistically significant difference.

An experimentation control service 312 can implement the evaluation of data sets at all stages of the model generation, testing, and validation stages. It is capable of evaluating models based purely on historic data or of evaluating data sets to determine how they should best be augmented to improve the ability to evaluate a decision model (e.g. through directed data collection).

A decision engine controller service 314 can coordinate the activities of the other decision engine services to realize the higher-level functionality for automatically adapting how the system interacts with participants, groups, and populations, over time. Coordination functions can themselves rely on decision engine services to implement, for example having a rules-based system define the criteria for initiating model creation and experimentation on a new population of participants.

The service control and data bus 316 is a common communication facility that all participant services can use to receive commands and to send responses. For example, the service control and data bus 316 can use a “publish/subscribe” methodology whereby services announce their presence and can optionally report their capabilities. The service then “subscribes” to a queue instantiated to hold control messages for the services and receives data from the queue. Other system components or other services within the decision engine 100 can “publish” commands/requests to the queue when functionality delivered by the service is needed. The commands/requests are then delivered to the subscribers.

The health system allows for health applications to be applied to participant populations associated with groups such as employer health plans and private organizations that may have overlapping functionality. For example, the participant populations may have available multiple types of online and mobile applications and access to and use of different types of biometric sensors and devices. Interaction options can be low-level details (for example, which among several possible educational health and wellness tips a participant should be presented with) to high-level decisions (for example, which of a set of weight management strategies to suggest to a participant). As new populations of participants are enrolled with the system, the system's decision engine determines the set of questions each participant will be presented as part of their enrollment. Answers to enrollment questions will also be used to determine both the health and wellness goals for the participant (e.g. daily target step counts) as well as decisions about how best to interact with the participant (e.g. which communication channels to rely on most heavily, what tone to use in communications, etc.).

The participants using the system can have multiple ways of accessing the system, e.g. through a web browser application or through a smart phone application. Each time the participant logs in to such an application or otherwise interacts with the system, the system can update the set of information available about the participant and make decisions that impact the current interaction. As an example, a health tip can be identified that is relevant to the recent activity of the participant or to an aspect of their health and wellness goal(s), or a question can be posed in order to complete the information needed about the participant to support a background model evaluation.

As a participant uses the health goal system, the system can adapt its interactions with the participants to improve their satisfaction and the results they will realize in using the system. The timing and modality of communications can adapt to the patterns of the participant, or models that have been tailored by recent data at the population level applied to the participant to make it more likely their health goal(s) will be achieved.

FIG. 4 shows an example of a log-in interface 400 appearing on a mobile device that interacts with the health system. The log-in interface 400 allows a participant to enter user credentials 402, for example, a user ID 404 and a password 406, to gain access to data made available by the health system.

FIG. 5 shows an example of a home screen interface 500 presented to a participant on a mobile device. The home screen interface 500 allows a participant to access resources of the health system. An Activity & Weight Data Goals button 502 provides the participant with information about the participant's progress on health goals. A Coaching & Tips button 504 provides the participant with guidance on how to further his progress in achieving a health goal. A myHealth Assessment button 506 provides the participant to provide feedback about his health to the system. A Kudos button 508 provides the participant with a list of “kudos,” which are awards representing health-related milestones that the participant has achieved. The home screen interface 500 also has other buttons 510 that provide access to other elements of the system.

FIG. 6 shows an example of an assessment interface 600 that can be accessed using the myHealth Assessment button 506 (FIG. 5). Here, the assessment interface 600 displays an assessment question 602. The assessment question 602 is presented to the participant to determine information about the participant based on the response. For example, the assessment question 602 presented in FIG. 6 asks the participant a question about the relationship between body weight and well-being. The participant is prompted to provide an answer 604 from a list of multiple choices. Here, the participant's answer can be used by the system to assess the participant's understanding of the topic of health.

FIG. 7 shows an example of a messages interface 700 that can be accessed using the Coaching & Tips button 504 (FIG. 5). The messages interface 700 provides feedback to the participant, for example, based on information about the participant available to the health system and based on one or more interventions applied to the participant. For example, the feedback can be the intervention messages 132 (FIG. 1). The messages interface 700 may display coaching tips 702 which provide the participant with feedback specific to the participant, for example, information about the participant's progress toward a health goal. The messages interface 700 may display health tips 704 which can be recommendations specific to a participant, specific to an intervention, or general recommendations applicable to any human being. Multiple coaching tips 702 and health tips 704 can be displayed, and the coaching tips 702 and health tips 704 can be chosen based on multiple interventions. For example, if a participant is receiving an intervention related to weight loss, and the participant is also receiving an intervention related to triglyceride reduction, a coaching tip 702 or health tip 704 may be displayed regarding the participant's sugar intake.

FIG. 8 shows an example of a statistics interface 800 that can be accessed using the Activity & Weight Data Goals button 502 (FIG. 5). The statistics interface 800 provides a participant with statistical data 802 relating to the participant's vital signs and health-related activities, for example, number of steps taken, calories consumed, minutes of exercise, distance walked, and the participant's body weight. The statistics interface 800 can include information about how the statistical data 802 related to the participant's health goals, for example, target values 804 and a determination of whether or not the participant is achieving the target values 806.

FIG. 9 shows an example of a milestones interface 900 that can be accessed using the Kudos button 508 (FIG. 5). The milestones interface provides the participant with a list of “kudos,” which are awards representing health-related milestones that the participant has achieved. For example, a participant who has remained active for at least thirty minutes a day and has walked two hundred steps within an hour may be awarded corresponding kudos 902, 904. The participant can also be presented with kudos 906 that have yet to be achieved to motivate the user to seek out the corresponding activities and achieve further milestones.

The interfaces shown in FIGS. 4 through 9 include examples of interventions that may be applied to a participant. These examples are not comprehensive and they demonstrate only a subset of many ways in which interventions can be used within the health goal system.

FIG. 10 shows an example of a coaching framework 1000. The coaching framework 1000 can be used, for example, to support coaching functionality of a health goal system 10 (FIG. 1). For example, the coaching tips 702 shown in FIG. 7 are an example of coaching functionality.

The coaching framework 1000 includes a coaching engine 1002 that determines how to coach a particular participant (e.g., the individual 106 shown in FIG. 1). The coaching engine 1002 calculates participant scores 1006 for each participant. The participant scores 1006 represent characteristics of interaction between the participant and the health goal system. For example, the participant scores 1006 can be used to measure engagement and outcomes for the participant. In some implementations, the participant scores may include the following:

1) Delta Quotient 1008—A score based on participant answers to questions and participant actions on the health goal system 10. The score predicts the likelihood that an individual will be able to succeed at changing their health behaviors. Components of the score also point to the areas in which the system can help the individual improve their chances at changing their health behavior. Examples include understanding an individual's feelings of control; attitudes toward health; and use of community/social supports. Put another way, the delta quotient 1008 indicates the likelihood that an individual will change in response to interacting with the health goal system 10, a characteristic sometimes called activation.
2) Engagement Score 1010—a score based on individual usage of online, web and email components of the health goal system 10 that predicts the likelihood that an individual will stay engaged with the system in the next 30 days. This score also points to specific areas of using the health goal system 10 that will increase the likelihood the individual participant will stay engaged. Interventions are designed for individuals based on their likelihood to disengage and using features of the system most likely to help them. Put another way, the engagement score 1010 indicates the likelihood that an individual will continue to use the health goal system 10.
3) Health Outcomes Score 1012—a score based on individual actions in the system cross referenced with an analysis of published health outcomes research that predicts the likelihood that an individual will achieve meaningful health outcomes. Put another way, the health outcomes score 1012 indicates the likelihood that an individual using the health goal system 10 will reach outcomes beneficial to his or her health.
4) Longitudinal Health Risk Score 1014—a score that reflects the health risks of an individual. The data is collected over time as an individual interacts with the system. The score is developed by the answers and actions of the individual each time the individual interacts with the health goal system 10. The score is continually updated and can reflect multiple years of health risk data and trends of the individual. Put another way, the longitudinal health risk score 1014 indicates the likelihood that an individual using the health goal system 10 is at risk for health problems.

Any of the participant scores 1006 can be determined based on data entered by an individual on a device 108 (FIG. 1). In some implementations, participants are assigned to clusters 305 (FIG. 3) based at least in part on one or more of the participant scores 1006 of the participant. For example, a cluster (also sometimes called a group) can be established based on multiple characteristics of the participants, for example, whether or not one of the participant scores 1006 is above or below a particular threshold, as well as other characteristics other than scores, e.g., demographics of the participant.

The coaching framework 1000 also includes coach conversation data 1016 that can be used to engage in coaching conversations 1018 that take place with a participant using a user interface of the health goal system 10 (e.g., the messages interface 700 shown in FIG. 7). The same coach conversation data 1016 can be used with all participants of the system. The coach conversation data 1016 can include branching decision and conversation trees that are triggered by different actions of a participant on the health goal system 10. The conversations may include observational statements by an automated coach with follow-up questions. Answers to the follow-up questions by the individual take the individuals through the decision/conversation tree. The conversations can take place in one user session or stretch over many days, weeks or months. The conversations are chosen to help individuals stay engaged in their health, increase their likelihood of positive health outcomes and limit their health risks. In some examples, coaching conversations 1018 are examples of interventions 122 (FIG. 1).

Together, the participant scores 1006 and the coaching conversations 1018 can be used to maintain an ongoing coaching strategy 1020 for a particular participant. For example, the coaching engine 1002 can choose from questions and conversations in the coaching conversation data 1016 to generate and update a coaching strategy 1020 for a participant. The particular questions and conversations in the coaching conversation data 1016 that are chosen can depend on the participant scores 1006. Questions provided to an individual in a coaching conversation 1018 could include questions of reflection, planning, barrier testing, reminders, and celebrations or acknowledgement of goals.

The coaching conversation data 1016 can include data used to construct a coaching conversation 1018. In some implementations, the coaching conversation data 1016 includes a category for each coaching conversation 1018, for example, “chronic/lifestyle” or “disease.” In some implementations, the coaching conversation data 1016 includes a trigger, e.g., an event that caused the coaching conversation 1018 to be generated. In some implementations, the coaching conversation data 1016 includes a coach interaction, e.g., questions to be asked of an individual. In some implementations, the coaching conversation data 1016 includes an identification of data to be collected in a conversation, e.g., answers expected from a user. In some implementations, the coaching conversation data 1016 includes interaction output, e.g., a suggestion to an individual, a challenge posed to an individual, an adjustment to a previous suggestion or challenge, or other output. In some implementations, the coaching conversation data 1016 includes a follow-up sequence, e.g., after an individual participates in a coaching conversation 1018, another coaching conversation may be triggered.

FIG. 11 shows an example of a scoring table 1100 that can be used to calculate the delta quotient 1008 for a particular participant. In some implementations, the questions 1102 of the scoring table 1100 are provided to participants (e.g., provided using the messages interface 700 shown in FIG. 7) and the responses 1104 are recorded. The scores 1106, 1108 in the scoring table are used to calculate the delta quotient based on responses of an individual. For example, a delta quotient of greater than 10 may represent a “sufficiently activated” participant; a delta quotient of 5 to 10 may represent a “questionable activation” participant; and a delta quotient of less than 5 may represent an “insufficient activation” participant. The coaching engine 1002 (FIG. 10) can use the delta quotient 1008 to choose a coaching strategy 1020 appropriate to the level of activation of the participant.

FIG. 12 shows an example of some of the variables 1200 that can be used to calculate the engagement score 1010 for an individual. For example, data representing the variables 1200 can be assigned numerical values and a score calculated from the numerical values.

The following is a description of some of the variables:

### Demographic:

Gender: indicates the gender of the individual
Chronic vs. non-chronic: indicates whether or not a participant has self-identified that they have a chronic disease such as hypertension, diabetes, etc.
Old vs. Young: indicates whether the individual is born before or after a specified year (e.g, 1970)
Disease Condition: indicates a self-identified disease condition (chronic disease), if any
BMI: indicates Body Mass Index, a ratio between height and weight modified by gender
Weight: indicates weight of the individual
Height: indicates height of the individual
Metro: indicates population density of where participant lives.

### Population:

Enrollment Communication: indicates a type of enrollment communications sent
Culture toward health: indicates how supportive of health is the culture surrounding the individual
Co-payment: indicates whether a sponsor has the participant pay any portion of fees for enrollment
Program: indicates a type of program offered, e.g. Activity, weight, diabetes, population health, etc.

### Behavioral Design:

Team Size: indicates if the individual was on a team and if that team was very large (hundreds) or smaller and more personal. For example, the individual may be engaging in a challenge to achieve a health goal, and in some examples may be on a team of people pursuing a challenge
Length of challenge: indicates how many weeks are involved in a current challenge the participant is enrolled in
Incentives: indicates any incentives that are offered for successful completion of the challenge
Expected value: indicates if a challenge incentive is a straight payout or a lottery
Number of challenges: indicates a number of challenges a participant has been involved in

### Intrinsic Motivations:

These indicate why the participant is using the system: e.g. managing a disease, a health event, family participation, etc.

### Coach Messaging:

Question Types: indicates why is the is question being asked; reflection, planning, barrier testing, reminders, celebration, etc.
Coach Question Attributes: indicates what do the participant answers tell us about them

### System Communication:

System Preference setting: indicates a frequency of communication, e.g., daily, weekly, none
Program communications preference setting: indicates a frequency of communication, e.g., daily, weekly, none

### Usability:

Technology Features: indicates what techniques used for communication, e.g., web, mobile, email, SMS
Usability: indicates how usable is the user interface, what other usability events were occurring in the system
Access to data: indicates barriers to getting the support or data that the individuals wanted to access

### Individual Behavior:

Tracker usage: indicates whether the participant set up and uses self-report trackers
Self-reporting vs. passive reporting: indicates whether the participant passively reports with a device and self-reports data, or just self-reports data

### Interactive Behavior:

Invited a friend: indicates whether the participant is creating a community to support them
Send messages: indicates whether the participant is sending secure messages to members of their community (utilizing the community)
Answering Questions: indicates whether the participant is responding to coach questions

### Gap in Behavior

Achievement vs. trackers: indicates whether the participant is hitting self-tracker goals
Achievement vs. challenge: indicates whether the participant is succeeding in sponsor defined challenges
Kudos trend: indicates whether the participant is gathering more kudos than past, fewer, or staying steady

### Engagement Metrics:

Logins: indicates how the user logs into the system and how frequently, e.g., web vs. mobile, days of the week
Uploaded device data: indicates whether the participant is sending device data (steps, weight, blood pressure, blood glucose)

### Outcomes:

Activity increased: indicates whether the participant increased their activity
Weight loss: indicates whether the participant reduced their weight
BP readings: indicates whether the participant reduced their blood pressure
Blood glucose: indicates whether the participant got their readings into the right ranges

FIG. 13 shows a chart 1300 that relates lifestyle factors 1302 to health outcomes 1304. For example, the lifestyle factors 1302 can be used as indicators for the health outcomes 1304. This relationships can be used to calculate a health outcomes score 1012. In this way, a health goal system 10 can use data about lifestyle factors 1302 to choose a course of action that is likely to affect the health outcomes 1304. For example, the course of action can be an intervention 130 (FIG. 1) and may include coaching conversations 1018 selected based on relationships between lifestyle factors 1302 of a participant and health outcomes 1304 pursued by the participant. The relationship (e.g., the relationship represented by the chart 1300) can be based on clinical measures (e.g., research studies) as well as data collected from the ongoing use of the health goal system 10 by participants.

In some examples, the lifestyle factors 1302 are chosen to focus on health outcomes 1304 that are recognized as specific, measureable, and biometric. Choosing clinical measures as primary outcomes and demonstrating evidence-based relationships with lifestyle factors enables the health goal system 10 to choose courses of action that are consistent with accepted medical knowledge and techniques. Further, lifestyle factors are a consistent set of metrics that can be measured in routine, short time intervals throughout a participant's use of the health goal system 10. In some implementations, the health goal system 10 can identify confounding factors (e.g., factors that cause an inconsistency in the known relationship between lifestyle factors and outcomes), which allows for more robust outcome evaluation and increased personalization of a participant's experience. Confounding factors could be chronic pain, depression, condition severity and/or duration, educational level of an individual, income of an individual, or other factors. The health outcomes score 1012 can be calculated based on how the individual has done with each lifestyle factor 1302 supported by the health goal system 10. For example, the progress of the individual on the lifestyle factors that are indicators of an outcome can be measured. If a participant is making progress in lifestyle areas that tie back to biometric outcomes tied to the area of focus or diagnosis then the participant is much more likely to have positive health outcomes. If a participant is making progress in lifestyle factors, but those areas are not shown to have strong correlation or are lacking evidence to support strong correlation to positive health outcomes then the participant is likely to have some positive health outcomes but not significant changes. If a participant is not making progress in lifestyle factors then the participant is evaluated to not have a good chance of having positive biometric health outcomes.

Each cell 1306, 1308 of the chart 1300 represents a relationship between a lifestyle factor 1302 of a participant and a health outcome 1304 pursued by the participant. A numerical value can be assigned to each cell 1306, 1308 of the chart 1300. A formula can be used that calculates the health outcomes score 1012 based on the numerical values of each cell 1306, 1308 and based on numerical data that represents how the individual has done with each lifestyle factor 1302 supported by the health goal system 10 (e.g., based on data collected during interventions).

FIG. 14 shows an example process 1400 for using a health outcomes score 1012 to help an individual pursue a health outcome. Each health outcome (e.g., one of the health outcomes 1304 shown in FIG. 13) has its own health outcomes score 1012. The health condition that a participant should be working on is identified 1402. For example, the health condition could be a disease such as diabetes. The categories that are the key measurable outcomes of that condition are identified 1404. For example, the outcomes can be identified based on medical knowledge. For example, if the condition is diabetes, an outcome could be a change in HbA1c level. The lifestyle factors that have the most impact on that biometric outcome can be identified 1406. For example, if the outcome is a change in HbA1c level, then the factors could be activity, nutrition, weight loss, and sleep. Interventions are selected 1408 from among interventions available in the system to help that individual achieve progress in those lifestyle factors. For example, the interventions could be among the interventions 122 shown in FIG. 1. This could include, for example, coaching conversations 1018 (FIG. 10). Based on data collected when the interventions are applied, the health outcomes score 1012 is calculated 1410 for the individual. This calculation can occur on an ongoing basis as the individual undergoes interventions. A higher health outcomes score 1012 indicates a higher likelihood of achieving particular health outcomes.

FIGS. 15A and 15B show an examples of a user interface 1500 that can collect data used in calculating a longitudinal health risk score 1014. In some examples, the longitudinal health risk score 1014 is initially determined using an initial health habit survey 1502 that is designed in a way that makes it likely that individuals will complete the survey. The longitudinal health risk score 1014 can be recalculated as an individual continues to use the health goal system 10. For example, the longitudinal health risk score 1014 can be recalculated based on data collected when interventions 122 (FIG. 1) are applied to an individual. Every 90 to 180 days the health habit survey 1502 can also be re-administered, with the same or different questions. The health habit survey 1502 can include questions 1504 directed to topics that may include physical activity, sleep, diet, stress, tobacco use, general health, chronic conditions, and medication management.

FIG. 16 shows an example of a user interface 1600 displaying a health habit assessment 1602. The health habit assessment 1602 represents the results of one or more administrations of the health habit survey 1502 shown in FIGS. 15A and 15B. For example, the health habit assessment 1602 can include columns representing results 1604, 1606 of each health habit survey 1502 administration. The longitudinal health risk score 1014 can be calculated based on the results 1604, 1606. For example, an answer to each question in each administration of the health habit survey 1502 can be assigned a numerical value. A formula for the longitudinal health risk score 1014 can calculate a value based on those numerical values as well as data gathered during interventions 122 (FIG. 1) applied to an individual. The longitudinal health risk score 1014 can be based on numerical values derived from multiple results 1604, 1606 of health habit survey 1502 administrations. For example, if the results 1604, 1606 indicate that an individual is improving his or her health habits, the longitudinal health risk score 1014 can indicate that the individual is at less risk for health problems than an individual whose health habits are trending away from improvement.

FIG. 17 shows an example of a coaching conversation 1700. The coaching conversation 1700 could be an example of one of the coaching conversations 1018 shown in FIG. 10. The coaching conversation 1700 is represented here as nodes 1702a-b, 1704a-b of a tree. Some of the nodes 1702a-b represent questions to be asked of an individual who is using a health goal system 10. For example, the questions can be displayed on a user interface such as the messages interface 700 shown in FIG. 7. Some of the nodes 1704a-b represent one of multiple choices that an individual may choose in response to the question represented by a parent node. Based on the response chosen by the individual, other questions can be asked of the individual to collect information about the individual's health. in some examples, the questions can be asked in response to information collected in the past. For example, a node 1702b can represent a question asked in follow-up to a question 1702a asked weeks prior. In this way, a coaching conversation 1700 can be used to collect information about how an individual's health state changes over time.

A coaching conversation 1700 can be triggered by one of several events. In some implementations, an event could be an evidence-based protocol, e.g., a protocol based on medical knowledge. For example, a newly diagnosed type 2 diabetes participant may be provided with conversations related to nutrition, eye care, foot care, and other topics that are known to relate to diabetes. In some implementations, an event could be a user event, such as data received from a device 108 (FIG. 1) or data entered by a user, e.g., in response to a question asked by the health goal system 10. In some implementations, an event could be a user experience feature. For example, as the participant engages with different features of the health goal system 10 (e.g., features that represent different aspects of the system's functionality), conversations related to those features can be triggered. In some implementations, an event could be an analytical insight. For example, if one of the participant scores 1006 crosses a threshold, a conversation could be triggered. The thresholds can be determined by the machine learning functionality of the decision engine 100 (FIG. 1).

FIG. 18 shows an example of a coach message queue 1800. The coach message queue 1800 can be used to space out questions and messages provided to a particular individual, for example, questions and messages provided as elements of coaching conversations 1018. In this way, the individual will not be provided with many questions or messages in a short amount of time. In some examples, a threshold value representing a maximum number of questions and messages for a particular amount of time can be used, e.g., a maximum of 10 questions and messages a day.

When the coaching engine 1002 determines that an element 1802, 1804 of a coaching conversation 1018 should be provided to an individual, the element 1802, 1804 is placed into the queue 1800. For each element 1802, 1804, the queue records a priority 1806, a name 1808, a category 1810, a start date 1812, and a finish date 1814. The priority 1806 is a numerical value and elements 1802, 1804 having a higher priority are provided to an individual ahead of those having a lower priority. Elements 1802, 1804 can also be provided based on the category 1810 so that, for example, the individual is not provided too many questions or messages (e.g., more than a threshold number of questions or messages) relating to a single category. The start date 1812 and finish date 1814 can be used to ensure that an element 1802, 1804 is provided to an individual within a specified timeframe.

FIGS. 19A-19C show an example of elements 1900a-c of a coaching conversation. For example, the coaching conversation could be an example of one of the coaching conversations 1018 shown in FIG. 10. Here, each element 1900a-c is a question posted to a participant, e.g., of the health goal system 10 shown in FIG. 1. The questions are posed to determine information about the participant's health as well as about the participant's engagement with the health goal system 10. The elements 1900a-c enable the participant to respond with answers that represent data that can be used, for example, to calculate one or more of the participant scores 1006 as shown in FIG. 10.

FIG. 20 shows a challenge user interface 2000. The challenge user interface 2000 presents challenges 2002, 2004, 2006, 2008 posed to a participant, e.g., of the health goal system 10 shown in FIG. 1. The challenges 2002, 2004, 2006, 2008 represent conditions that can be achieved based on activities of a participant, e.g., health activities. For example, a condition can be achieved if a threshold is met. When all conditions of a challenge are achieved, the challenge can be said to have been accomplished. In some examples, a challenge could be an example of one or more elements of one of the coaching conversations 1018 shown in FIG. 10.

A challenge 2008 can be a team challenge, for example, a challenge that is accomplished when the combined efforts of multiple participants achieve the conditions of the challenge 2008, e.g., meet thresholds defined by the conditions.

Although an example health goal system has been described in FIG. 1 as using computer systems and mobile devices, for example, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as software for processing health data or communicating intervention messages, can be implemented as one or more computer program products, i.e., one or more modules or engines of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them. A computer system could be a single computer or multiple computers and could include a single microprocessor or multiple microprocessors. A first computer executing one computer program and a second computer executing a second computer program could together be considered to be a single computer system.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the health goal system can be interconnected by any form or medium of digital data communication, e.g., a communication network. Examples of communication networks include a local area network (“LAN”) and a wide area network (“WAN”), e.g., the Internet.

Other implementations are within the scope of the following claims.

1. A computer-implemented method comprising
on successive occasions over a period of time, gathering measured data and self-reported data that represent health states of participants in a health goal system;
based on at least some of the gathered data, determining, by machine learning, data representing a relationship between sequences of self-applied interventions and health states of participants who belong to respective groups that share similar characteristics;
calculating scores representing characteristics of interactions between participants and the health goal system; and
based on the scores and the data determined by machine learning, choosing elements of conversations to be provided to the participants, elements of the conversations being chosen to affect (i) health behaviors, (ii) health states, (iii) health awareness, (iv) health engagement, or a combination of any two or more of them, of the participants,
the elements of the conversations comprising questions posed to the participants on user interfaces of electronic devices.

2. The method of claim 1 in which one of the scores comprises an indication of the likelihood that an individual will change health behaviors in response to interacting with the health goal system.

3. The method of claim 1 in which one of the scores comprises an indication of the likelihood that an individual will continue to use the health goal system.

4. The method of claim 1 in which one of the scores comprises an indication of the likelihood that an individual using the health goal system will reach outcomes beneficial to his or her health.

5. The method of claim 4 in which the score is calculated based on at least one relationship between a lifestyle factor and an outcome.

6. The method of claim 5 in which the score is calculated over time based on changes in the relationship over time.

7. The method of claim 4 in which the score is calculated based on confounding factors.

8. The method of claim 1 in which one of the scores comprises an indication of the likelihood that an individual using the health goal system is at risk for health problems.

9. The method of claim 8 in which the score is determined based on a health habit assessment provided to the individual.

10. The method of claim 8 in which the score is determined based on changes over the course of multiple administrations of the health habit assessment.

11. The method of claim 1 comprising generating the conversations based on a tree of relationships among questions and answers.

12. The method of claim 1 comprising providing the conversations based on trigger events associated with each conversation.

13. The method of claim 1 comprising providing elements of the conversations at times determined based on a queue containing the elements.

14. The method of claim 13 in which the queue comprises a priority for each element.

15. The method of claim 1 comprising establishing one of the groups based on multiple characteristics shared by participants of the group.

16. The method of claim 1 in which at least one of the multiple characteristics is determined based on at least one of the scores.

17. A system comprising
a coaching engine executable on a computer system and configured to pose, in a user interface, conversations chosen to receive data from a participant of a health goal system, and
determine, based on the received data, at least one of (i) an indication of the likelihood that an individual will change health behaviors in response to interacting with the health goal system, (ii) an indication of the likelihood that an individual will continue to use the health goal system, (iii) an indication of the likelihood that an individual using the health goal system will reach outcomes beneficial to his or her health, and (iv) an indication of the likelihood that an individual using the health goal system is at risk for health problems.

18. The system of claim 17, comprising a decision engine executable on the computer system and configured to, based on the determined indications, choose an intervention expected to affect, for the participant (i) a health behavior, (ii) the health state, (iii) a health awareness, or (iv) health engagement, or a combination of any two or more of them, of the participant.

19. A computer readable storage device storing a computer program product including machine-readable instructions that, when executed by a computer system, carry out operations comprising:
providing, on a user interface of an electronic device, elements of conversations chosen based on an identity of a user of the electronic device, the user being associated with a health goal system that chooses interventions expected to affect, for the user (i) a health behavior, (ii) the health state, (iii) a health awareness, or (iv) health engagement, or a combination of any two or more of them, of the participant,
in which providing the conversations comprises prompting the user to enter data usable to generate scores indicative of (i) the likelihood that an individual will change health behaviors in response to interacting with the health goal system, (ii) the likelihood that an individual will continue to use the health goal system, (iii) the likelihood that an individual using the health goal system will reach outcomes beneficial to his or her health, and (iv) the likelihood that an individual using the health goal system is at risk for health problems.

20. The computer readable storage device of claim 19 in which at least one of the conversations is chosen based on a previous conversation provided to the user.

21. The computer readable storage device of claim 19 in which at least one of the conversations is chosen based on data received from a device used by the user.

22. The computer readable storage device of claim 19 in which at least one of the conversations is chosen based on a change in one of the scores.

23. The computer readable storage device of claim 19 in which at least one of the conversations is chosen based an action of the user with respect to the user interface.

24. The computer readable storage device of claim 19 in which at least one of the conversations comprises a challenge posed to the user.
